(19) United States
(12) Patent Application Publication
(10) Pub. No.: US 2018/0289233 A1
(43) Pub. Date: Oct. 11, 2018

(54) Double Bladed Surface Cleaning Squeegee Device

(71) Applicant: Larry Daniel, Bryan, TX (US)

(72) Inventor: Larry Daniel, Bryan, TX (US)

(21) Appl. No.: 15/482,962

(22) Filed: Apr. 10, 2017

(51) Int. Cl. A47L 13/11; A47L 13/42; B44D 3/00

(52) U.S. Cl. CPC A47L 13/11; B05B 15/0437; B44D 3/006; A47L 13/42

(57) ABSTRACT

A squeegee tool adapted to selectively engage and clean a paint shield blade. The squeegee tool having arms pivotally connected to one another, each with an elongated squeegee blade support frame extending at right angles with a longitudinal axis of the respective support arms. The arms have a reverse overlapping corresponding end configuration at the squeegee's point of attachment and oppositely disposed handles on their respective free ends. The handles are spring urged apart requiring the user to grip and compress to open the squeegee tool to engage it onto the paint shield allowing the individual to clean the shield.

### CROSS-REFERENCES TO RELATED APPLICATIONS (IF ANY)

None.

### BACKGROUND

### 1. Field of the Invention

This invention relates to squeegees and squeegee enabled devices that have flexible elongated resilient blades that are typically dragged across a surface, such as glass to remove material such as water or the like.

### 2. Description of Prior Art

Professional spray painters often use a paint shield. The paint shield must be cleaned after use. This is a labor, water, and cleaning product intensive process. An individual applies water with paint thinner or cleaners and uses a rag to wipe off paint. Scraping tools may be employed to remove excess paint. Some painters will also use cheap, disposable paint shields to reduce costs associated with cleaning.

Prior Art devices of this type have for the most part been directed to single blade squeegees having a multitude of supports and engagement handles. Other prior art devices combine a scissors like support with opposing jaws, see for example U.S. Pat. Nos. 4,716,677 and 7,430,781.

In U.S. Pat. No. 4,716,677 a scissors frame device is disclosed with a pair of jaws having pads thereon which are used to engage and clean the upper and lower surfaces of a leaf on a plant.

In U.S. Pat. No. 7,430,781 claims a window blind cleaning system having a pair of cleaning heads on extensible arms allowing the heads to be closed over the window blind element for cleaning.

There is still room for improvement in the art.

### SUMMARY OF THE INVENTION

The current invention is a double-bladed squeegee device intended for cleaning solid surfaces, such as paint shields.

A paint shield is formed of an elongated thin flat body member typically of metal or synthetic resin having a positioning and holding handle extending therefrom. Paint shields afford the user the ability to rapidly position a surface shield against an edge surface during the application of paint typically during spraying. The shield prevents overspray and can be repositioned rapidly for continued use.

The device is in a straight-line setup, composed of a handle, parallel blade arms, and replaceable rubber blades. The paint shield cleaning device of the invention provides a pair of parallel elongated squeegee blades mounted to a scissors like spring urged handle that can be selectively engaged on the shield surface and drawn thereacross, wiping the shield clean of accumulated paint so it is ready for continued use.

The handle is a durable, but semi-flexible material. The default position will hold the blades slightly apart. To use, the blades are placed one on each side of a paint shield. When the handle is squeezed, the blades are engaged and the device is dragged down the paint shield. Excess paint is removed from the surface.

The blades are replaceable. The blade is removed by sliding out from a groove. The process is reversed to install the new blade. A paint shield cleaning device providing a pair of spring urged squeegees for selective engagement and movement on and over the surface of a paint shield.

### BRIEF DESCRIPTION OF THE DRAWINGS

Without restricting the full scope of this invention, the preferred form of this invention is illustrated in the following drawings:

FIG. 1 is a perspective view of the paint shield cleaning device of the invention;

FIG. 2 is a front elevational view thereof with portions illustrated in broken lines showing repositioning of attached squeegee blades;

FIG. 3 is a top plan view thereof;

FIG. 4 is a partial perspective view of the paint shield cleaning device in use on a paint shield;

FIG. 5 shows another embodiment with a different type of handle; and

FIG. 6 shows the other embodiment with a blade arm removed and the rubber blade partially removed.

### DESCRIPTION OF THE PREFERRED EMBODIMENT

There are a number of significant design features and improvements incorporated within the invention.

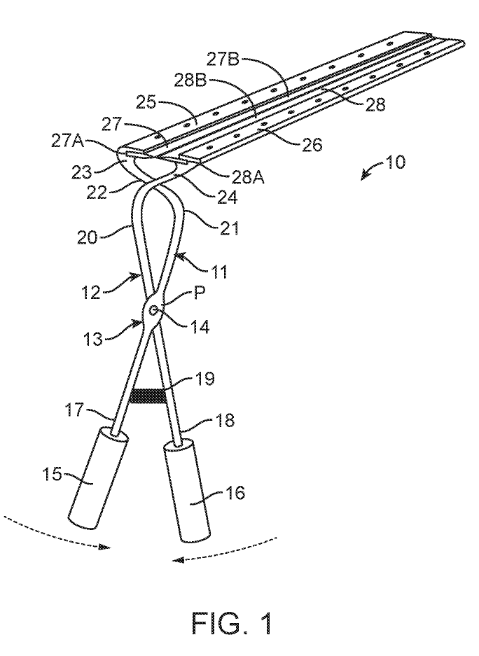

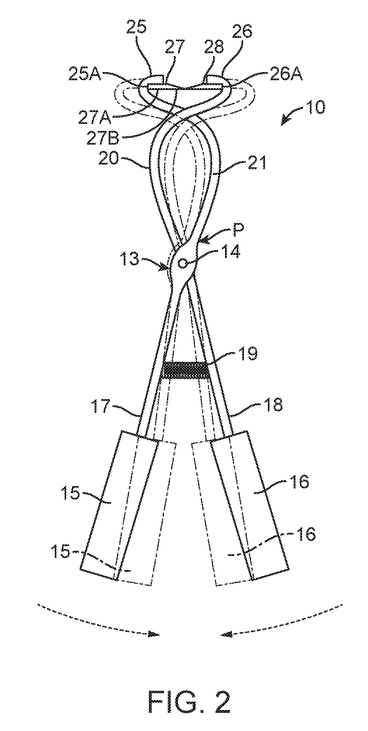

Referring to FIGS. 1 and 2 of the drawings, a paint shield cleaning device 10 of the invention can be seen having a pair of squeegee blade support arms 11 and 12 pivotally secured to one another forming a scissors like configuration. Each of the arms 11 and 12 are preferably formed of cylindrical rod material having a central apertured area 13 through which a pivot pin 14 extends. A pair of handle grips 15 and 16 are secured to the respective arm end portions 17 and 18 with a resilient spring fitting 19, in this example, extending between the arms 11 and 12 midway between the arms pivot point and the handgrips 15 and 16.

The spring fitting 19 maintains a spring urged separation of the arms 11 and 12 and accordingly the correspondingly attached handgrips 15 and 16 as will be well known and understood by those skilled in the art. It will also be noted that a variety of spring enabled fittings may be used inclusive, but not limited to a coil spring assembly, as shown.

Each of the arms 11 and 12 has a contoured squeegee engagement end portions 20 and 21 respectively thereon. The contoured arm end portions curve oppositely from one another after the pivot point P and then back towards one another crossing at 22 each having a reversed end curve portions 23 and 24 respectively.

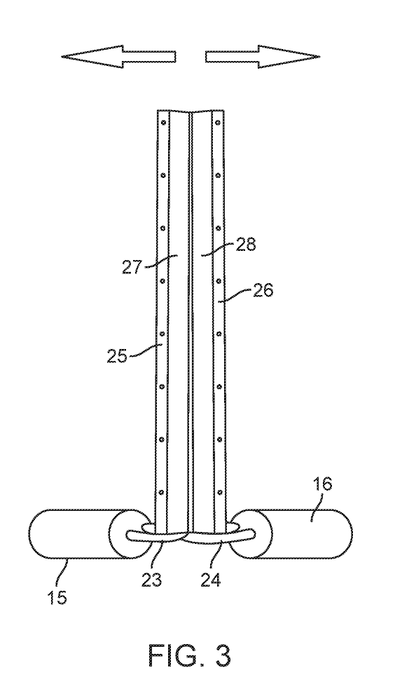

The reverse end curve portions 23 and 24 each have transitional attachment to respective elongated squeegee mounting frames 25 and 26, best seen in FIGS. 1 and 3 of the drawings.

Each of the squeegee mounting frames 25 and 26 each have a respective engagement channel 25A and 26B which extends in spaced parallel relation to one another as shown in FIG. 3 of the drawings.

Squeegee blade inserts 27 and 28 are fitably retained within each of the respective channels 25A and 26B in parallel effacing relation to one another. Each of the squeegee blade inserts 27 and 28 is formed from a synthetic resin material in a continuous flat band of uniform transverse dimension. The squeegee bands are of a dimensional edge thickness at 27A and 28A so as to be inserted and retained within the respective engagement channels 25A and 26B as described. The squeegee blade inserts 27 and 28 have by definition an elongated taper mounting engagement edges at 27B and 28B affording the squeegee the deflection required so as to be imparted when engaged on the opposing upper and lower surfaces S of a typical paint shield 29 and then drawn across during use as will be disclosed in greater detail hereinafter.

It will be seen from the above description that as assembled the respective squeegee blade inserts 27 and 28 are held and urged together by the spring urged arms 11 and 12.

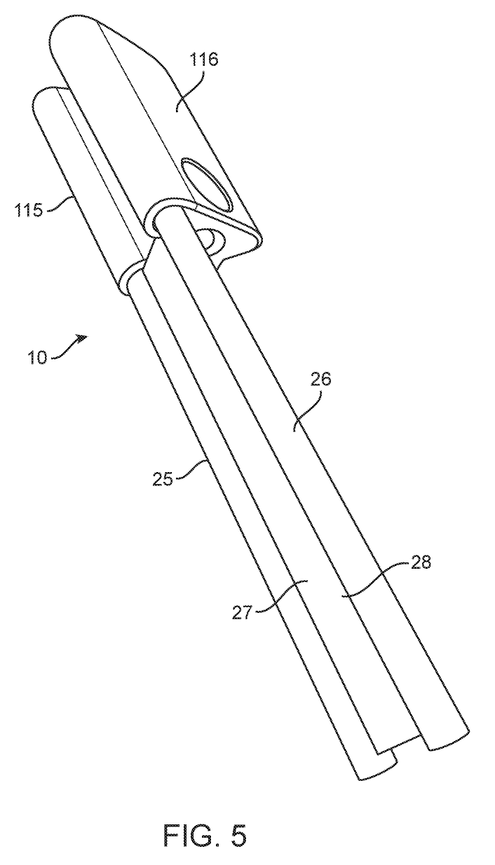

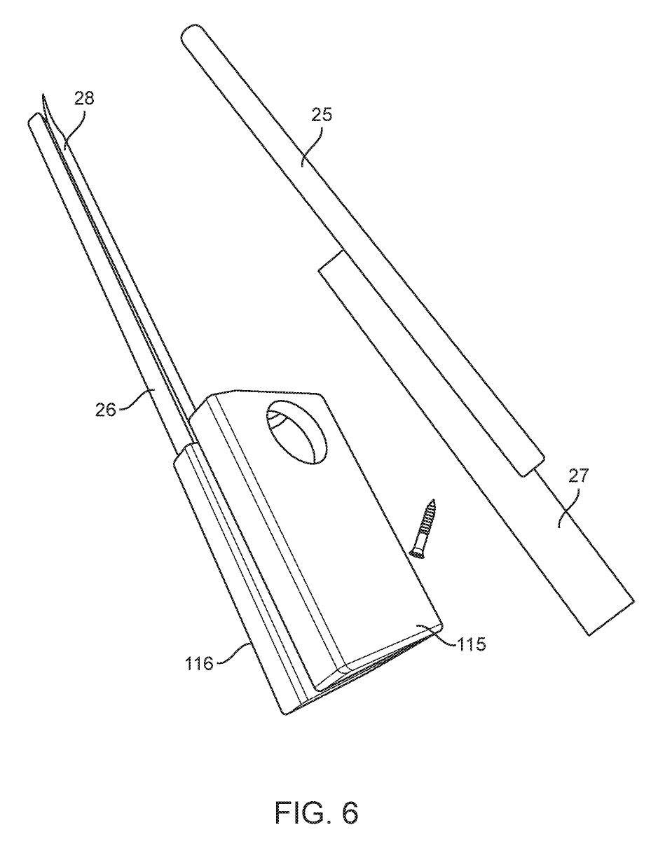

Different styles and types of handles can be used. Referring to FIGS. 5 and 6 of the drawings, the squeegee blade support arms serves as the handgrips 115 and 116 that are connected at a pivot pin forming a “V” shape configuration. This configuration is design so that the handle can be held easily in a user's hand. The handgrips 115 and 116 are covered with a soft form like material. This configuration does not have rods as the squeegee mounting frames 25 and 26 are connected directly perpendicular to the top end of the handles.

The Squeegee blade inserts 27 and 28 are replaceable. The blade is removed by sliding out from their respective engagement channels 25A and 26B. The process is reversed to install the new blade FIG. 6 shows the Squeegee blade inserts 27 and 28 being removed from the squeegee mounting frames 25 and 26 from the “V” shape configuration.

### Operation

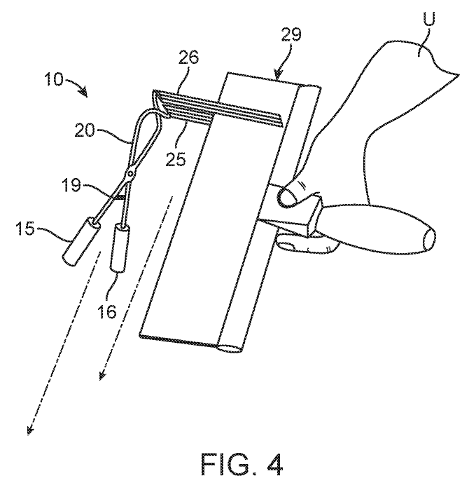

A “squeeze to close” method is best to be able to control the tool and shield with ease. This will allow a user to conform to the flexibility of the shield. In operation, on the paint shield 29, a user U seen in FIG. 4 of the drawings would grasp the hereinbefore described handgrips 15 and 16 together to separate the squeegee blades 27 and 28 for ease of positioning engagement on the paint shield 29. The user U would then simply draw the paint shield cleaning device 10 of the invention along the engaged shield's surface indicated by directional arrow in FIG. 4 of the drawings effectively squeegeeing the shield's surface of accumulated material, thus presenting it for continued use.

### Advantages

The innovative squeegees make cleaning paint shields quick and easy. Current cleaning methods use huge amounts of water, cleaning products, and can require a full-time staff member dedicated to cleaning. This squeegee is cheap and easy to use, eliminating the need for dedicated cleaning tasks. By squeegeeing the paint shield clean, the excess paint can be put in the paint bucket, saving up to 1.5 gallons of paint for every 10 gallons sprayed. This has additional water and environmental benefits, as it will reduce the amount of water used for cleaning and the amount of chemicals disposed of on the ground. The device comes with interchangeable blades, which means that there is no need to buy a new one every time it starts to get dirty.

Although the present invention has been described in considerable detail with reference to certain preferred versions thereof, other versions are possible such as different tension means, bobber shapes and sizes and different colored lights. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A paint shield cleaning device comprising:
having a pair of squeegee blade support arms pivotally secured to one another using a connection means where the arms have a top where squeegee mounting frames are connect where the squeegee mounting frames where each of the squeegee mounting frames have a respective engagement channel which extends in spaced parallel relation to one another with squeegee blade inserts that are retained within each of the respective channels.

2. A device according to claim 1 further comprising:
Where the squeegee blade support arms form a scissors like configuration.

3. A device according to claim 2 further comprising:
Where each of the arms are formed of cylindrical rod material.

4. A device according to claim 2 further comprising:
Having a pair of hand grips attached to the arms.

5. A device according to claim 4 further comprising:
Where the arms have two ends with the connection means centrally local and having hand grips attached to the arms on the opposite end that the squeegee mounting frames are attached.

6. A device according to claim 4 further comprising:
Having a spring fitting between the two arms.

7. A device according to claim 2 further comprising:
Where the connection means is a pivot pen.

8. A device according to claim 2 further comprising:
Where the squeegee blade inserts are formed from a synthetic resin material in a continuous flat band of uniform transverse dimension.

9. A device according to claim 2 further comprising:
Where the squeegee blade inserts are replaceable.

10. A device according to claim 1 further comprising:
Where the squeegee blade support arms form a “V” like configuration.

11. A device according to claim 10 further comprising:
Where each of the arms are formed of cylindrical rod material.

12. A device according to claim 10 further comprising:
Where the arms have two ends with the connection means centrally local and having hand grips attached to the arms on the opposite end that the squeegee mounting frames are attached.

13. A device according to claim 10 further comprising:
Having the arms covered in a form type material.

14. A device according to claim 10 further comprising:
Where the connection means is a pivot pen.

15. A device according to claim 10 further comprising:
Where the squeegee blade inserts are formed from a synthetic resin material in a continuous flat band of uniform transverse dimension.

16. A device according to claim 2 further comprising:
Where the squeegee blade inserts are replaceable.

17. A process to clean a paint shield using the device of claim 1.
